(19) United States
(12) Patent Application Publication
(10) Pub. No.: US 2004/0066505 A1
(43) Pub. Date: Apr. 8, 2004

(54) Apparatus and method to inspect objects

(76) Inventors: David M. Berg, Rochester, NY (US); Walter E. Johnson, Bloomfield, NY (US)

Correspondence Address: Steven R. Scott, Eugene Stephens & Associates, 56 Windsor Street, Rochester, NY, 14605, US

(21) Appl. No.: 10/264,737

(22) Filed: Oct. 4, 2002

(51) Int. Cl. G01N 21/00

(52) U.S. Cl. 356/237.1

(57) ABSTRACT

This apparatus and method to inspect objects uses a plurality of pairs of plane mirrors, a lens, a single image sensing means, and illuminating means. The pairs of plane mirrors are arranged in a radially symmetrical pattern about the optical axis of the lens. The object to be viewed (typically a cylindrical object) is placed with its axis coincident with the optical axis of the lens and illuminated by the illumination means. Light travels from the object to the first or outer plane reflective surface of each pair, then to the second or inner plane reflective surface of each pair, and then to the lens that forms an image on the image sensing means. By the symmetry of the arrangement, each pair of reflective surfaces provides a similar image of the object, only from a different direction. These images can provide a complete view around the circumference of the object with overlap between adjacent views.

### TECHNICAL FIELD

Our invention pertains generally to the field of lenses, mirrors, and optical devices. More particularly, it deals with a novel system allowing a simultaneous view from all sides of an object—i.e.—a full 360 degree optical inspection of an object via a single lens or inspection point.

### BACKGROUND

In the field of machine vision and video inspection, it is often necessary to inspect the total inner or outer circumference of a cylindrical object. For example, in battery construction it is necessary to assure that a bead of bonding material is evenly and properly distributed around the interior edge of the end of a cylinder before moving to the next step in constructing the battery. Inspection can be accomplished with multiple lenses and cameras with each camera having a separate and generally overlapping view. (Such cameras would be mounted at an acute angle to the axis of the battery so as to view the interior edge of the battery cylinder.) Alternatively, it can be done with a single camera mounted in the same way by rotating the battery so as to bring different portions of its interior edge before the camera. (Moving the camera around the object would be much more awkward and expensive.) However, all of these methods are expensive and can take up too much space. Thus, there is a great need for less expensive and cumbersome means of inspecting the entire circumference of the cylinder. This inspection requirement can be for either the outer aspect or the inner aspect of the cylinder. In addition, it may be required that the inspection means not surround the cylinder itself. This allows the cylinder to be transported in a direction perpendicular to its axis without hindrance (like, for example, a work piece being moved on a linear belt). At present, there is no practical optical system that allows simultaneous 360 degree inspection via a single lens or optical system (i.e.—via a single camera) of a cylindrical object in a manner that does not block movement of the object perpendicular to its axis.

### SUMMARY OF INVENTION

Our invention includes a plurality of pairs of plane reflective surfaces (mirrors), a single lens, a single image sensing means, and illuminating means. These pairs of plane reflective surfaces are arranged in a radially symmetrical pattern about the optical axis of the lens. The object to be viewed (typically a cylindrical object) is placed with its axis coincident with the optical axis of the lens. The object is illuminated by the illumination means. Light travels from the object to the first or outer plane reflective surface of each pair, then to the second or inner plane reflective surface of each pair, and then to the lens that forms an image on the image sensing means. By the symmetry of the arrangement, each pair of reflective surfaces provides a similar image of the object, only from a different direction. For example, in the case of four pairs evenly spaced around the optical axis of the lens, four images are created, each from a perspective 90 degrees rotated about the cylinder. These images provide a complete view around the circumference of the object (or cylinder), with overlap between adjacent views.

One of the primary innovations embodied in the aforesaid arrangement lies in the radial symmetry of the sets of mirror pairs. This arrangement provides images from several perspectives that are simultaneously in focus. It is not obvious that a system can be constructed that meets this requirement without one component interfering or blocking the light from another component. The only similar system known to us is a lens form known as an axicon. An axicon consists of an outer annular mirror—actually a truncated cone—and an inner conical mirror. To a certain extent, our invention may be viewed as an extension of the axicon idea by substituting a finite number of correctly oriented plane segments for the continuous curve of the axicon. This extension has several advantages. First, axicon lenses are difficult to fabricate. The present invention can be constructed using plane mirrors and prisms with plane faces. Second, the image from an axicon may be difficult to interpret because each point of the image is viewed with (and distorted by) curved surfaces. In the present invention, each pair of plane mirrors provides a simple perspective view. The “curved” aspect of the axicon is absorbed in the narrow breaks between segments, where no image information is carried. Also, as previously noted, all images received are simultaneously in focus and undistorted.

### DRAWINGS

FIG. 1 provides a side view of our invention positioned for the inspection of a cylindrical object.

FIG. 2 provides a cross-sectional view taken through line 2-2 of FIG. 1.

FIG. 3A provides a cross-sectional view taken through line 3-3 of FIG. 2.

FIG. 3B provides a more detailed view of the illumination means illustrated in FIG. 3A.

FIG. 4 provides a cross-sectional view taken through line 4-4 of FIG. 2.

FIG. 5 provides a cross-sectional view taken through line 5-5 of FIG. 4 showing only the first mirrors of our invention and their supporting structure.

FIG. 6 provides a schematic view of our invention from the side with multiple pairs of reflective surfaces being used to view the interior of a cylinder.

FIG. 7 provides a schematic view of our invention from above with multiple pairs of reflective surfaces being used to view a cylinder.

FIG. 8 provides a partially schematic view illustrating overlapping images of the interior peripheral edge of a cylinder.

### DETAILED DESCRIPTION

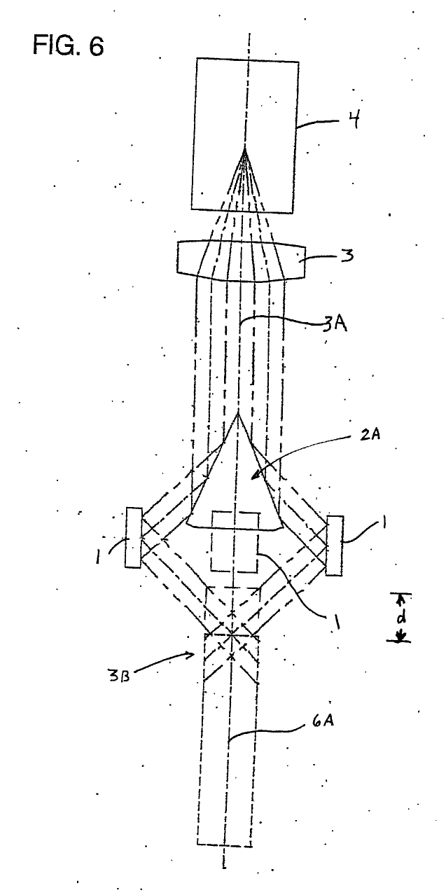

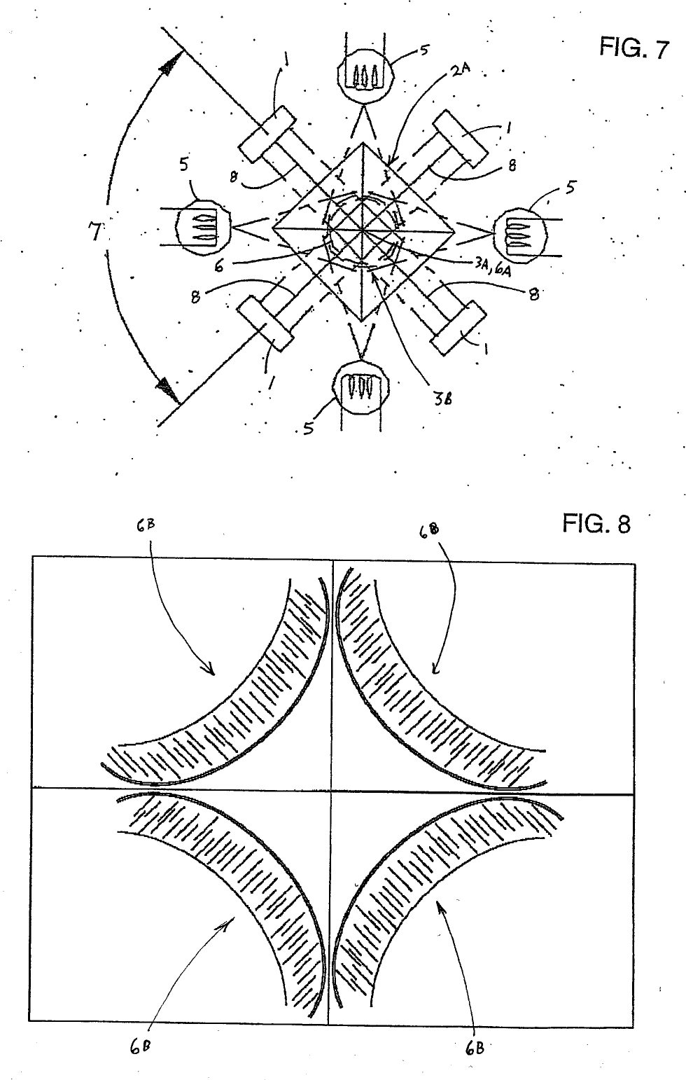

In its most basic embodiment, our invention consists of a pair of reflective surfaces comprising a first plane reflective surface (first mirror 1), a second plane reflective surface (second mirror 2), and a lens 3. (See, generally, FIGS. 6 and 7.) However, in almost any practical application, it will include a plurality of pairs of reflective surfaces (mirrors 1, 2); a single image sensing means (such as camera 4); and illuminating means (lights 5) for lighting an object such as cylindrical object 6. The reflective surfaces (mirrors 1, 2) and preferably illuminating means (lights 5) are arranged in a radially symmetrical pattern about the optical axis 3A of lens 3.

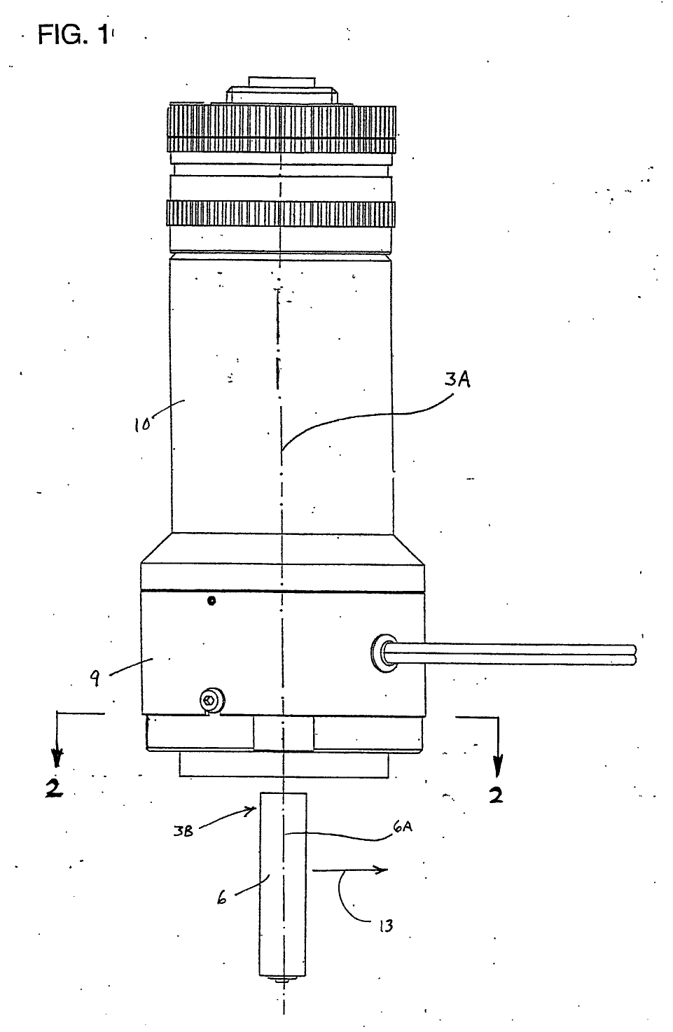

For best results, cylindrical object 6 is placed with its axis 6A coincident with the optical axis 3A of lens 3 in a zone of examination 3B located on optical axis 3A. (See FIGS. 1, 6, and 7.) Object 6 is illuminated by the illumination means (lights 5). Light travels from cylindrical object 6 to the first or outer plane reflective surface (mirror 1), then to the second or inner plane reflective surface (mirror 2), and then to the lens 3 that forms an image on the image sensing apparatus (camera 4). By the symmetry of the arrangement, each pair of mirrors 1, 2 provides a similar image of an object located in the zone of examination 3B, only from a different direction. For example, in the case of four evenly spaced pairs, four images 6B are created, each from a perspective 90 degrees rotated about cylindrical object 6 (See, FIG. 8). These images provide a complete view of the circumference of the cylindrical object 6, with overlap between adjacent views. This can be an interior circumference (as illustrated in FIGS. 6 and 8). Alternatively, it can be an exterior circumference (as, for example, would be provided by lifting cylindrical object 6 by distance “d” as shown in FIG. 6 and adjusting lens 3 and camera 4 to refocus the image of object 6).

Although irregular spacing is possible, best results will be achieved in most cases by evenly spacing each pair of mirrors 1, 2 about optical axis 3a such that all are spaced at equal angles 7 about optical axis 3a. Also, as will be noted from review of the preferred embodiments illustrated, surface normals 8 of each pair of mirrors 1, 2 will lie in a plane including optical axis 3a with, preferably, the surface normal 8 of first mirrors 1 being perpendicular to optical axis 3a. (These factors can, however, be varied as necessary to ensure that an appropriate image area is reflected via mirrors 1, 2 to lens 3.) In addition, all mirrors 1, 2 are plane mirrors so that they serve only to redirect light without introducing power or otherwise transforming said light with consequent distortions of the image conveyed.

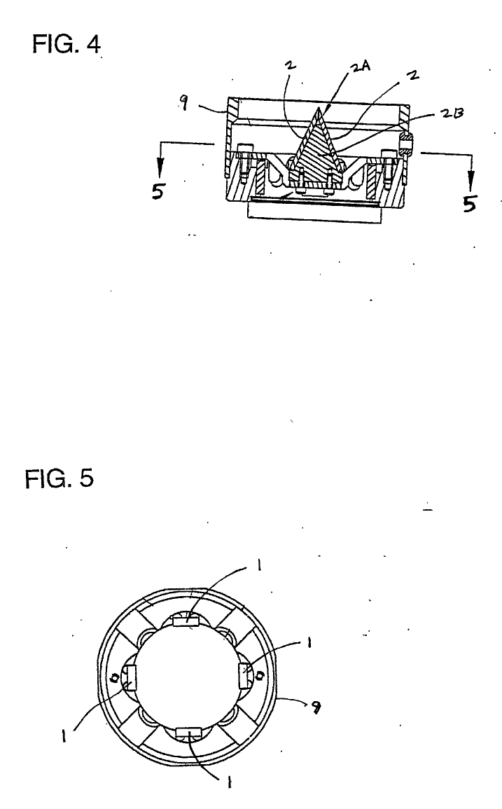

As illustrated in the drawing figures, we have found it preferable to consolidate mirrors 2 at optical axis 3a so as to form a single reflective element (denoted generally by arrow 2a) with mirrors 2 forming the facets thereof. Reflective element 2A can be fabricated as a single piece with a plurality of facets or by assembling mirrors 2 onto a separate structural member 2B as shown in FIGS. 1 through 5. (Mirrors 2 can be separate, but can also be formed by folding a single object of a reflective material such as reflective plastic.) Mirrors 2 are disposed at such an angle that light from cylindrical object 6, after impinging on mirrors 1 and passing from mirrors 1 to mirrors 2, is rendered substantially parallel to optical axis 3a. (As will also be noted, mirrors 1, 2 are shaped so that the reflecting surface of each mirror 1, 2 does not extend beyond the front surface of any adjacent mirror 1, 2.) Light then passes through lens 3 and is imaged onto sensing apparatus (camera 4). Preferably, lens 3 is substantially telecentric so that the light from cylindrical object 6 conveyed by mirrors 1, 2 to lens 3 substantially parallel to optical axis 3a coincides with the chief rays entering lens 3.

More particular details related to the construction of a preferred embodiment of our invention can be derived from review of FIGS. 1 through 5. In this embodiment, the mirror pairs 1, 2 are held in proper spaced relationship within a mirror housing 9 coupled to lens housing 10. Inside mirror housing 9, support structure 11 holds structural member 2B with its second mirrors 2 in proper spaced relationship and orientation to first mirrors 1. Properly spaced and sized apertures (denoted by arrows 12) in support structure 11 allow light to pass from first mirrors 1 through support structure 11 to second mirrors 2. The closed structure created by mirror housing 9 and support structure 11 function together so as to assure that very little light reaches lens 3 except that reflected by mirrors 1, 2 from zone of examination 3B through apertures 12.

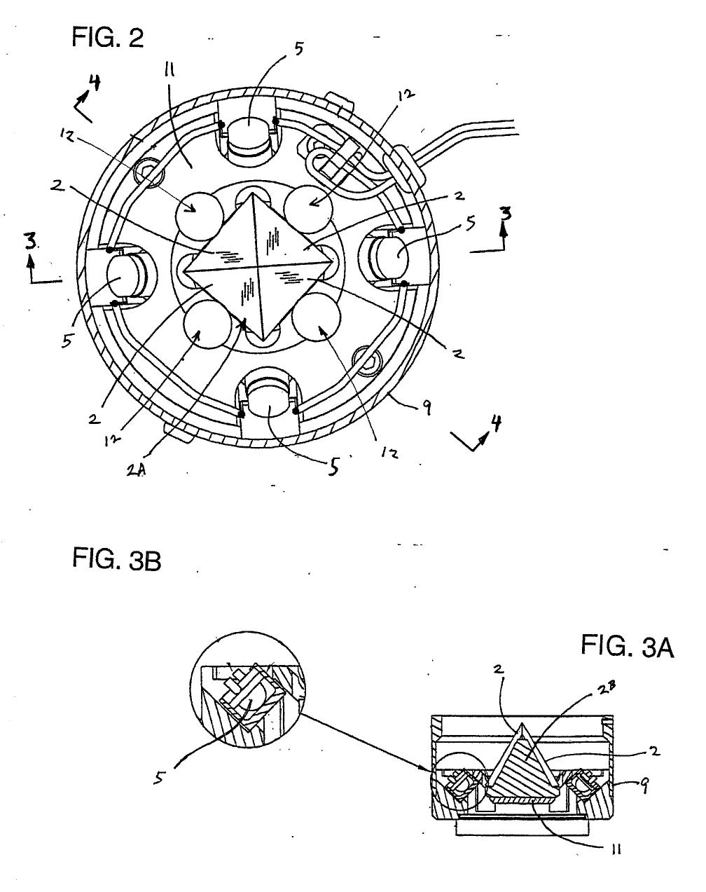

Support structure 11 also holds lights 5. Incandescent bulbs, LEDs, the output of optic fiber bundles, or other illumination sources can be used for this purpose; however, as shown in FIGS. 2 through 3B we have found LEDs to be the most advantageous choice. In an application of this type, a ring light would normally be used. Unfortunately, such a light (which would be positioned beneath support structure 11) would block apertures 12. Lights 5 are positioned so as to emit their illumination beneath support structure 11. They are also oriented and evenly spaced so as to fully illuminate cylindrical object 6 (a battery) from all sides like a ring light without blocking apertures 12, shining directly into lens 3, and otherwise interfering with light passing from zone of examination 3B to mirrors 1, 2.

The width of mirrors 1, 2 and their distance and orientation with respect to cylindrical object 6 are chosen so as to assure that substantially only the image of cylindrical object 6 is reflected to second mirrors 2, reflecting only minimally anything beyond or around cylindrical object 6. Otherwise, details would be reflected that are not pertinent to the examination of cylindrical object 6. This would be confusing to a human viewer. It would also render the images received more difficult to evaluate via the interpretive software adapted for use in this type of application.

For manufacturing purposes, our invention makes it possible for cylindrical object 6 to be moved freely in virtually any direction (except directly upwards along optical axis 3A). Thus, it can be moved to, through, and/or away from the zone of examination 3B in any direction perpendicular to optical axis 3A (such as that indicated by arrow 13) without being hindered by our apparatus.

The foregoing description provides information about the more general aspects of our invention as well as a particular preferred embodiment thereof. However, numerous variations are possible without exceeding the scope and ambit of our inventive concept. Thus, for a better understanding of our inventive concept and the scope of our invention, reference should be made to the claims that follow.

We claim:

1. An apparatus for examining objects, comprising:
a plurality of mirror pairs arranged around an optical axis, each pair being comprised of a first mirror and a second mirror, with the first mirror of each pair being proximate a zone of examination intersected by said optical axis and the second mirror of each pair being more distant from the zone of examination, the mirrors of each pair being arranged so that light from the zone of examination impinging on the first mirror of each pair is reflected to the second mirror of each pair and is then reflected from the second mirror of each pair away from the zone of examination and parallel to the optical axis;
a substantially telecentric lens located and arranged on said optical axis such that the light reflected from the second mirrors substantially parallel to said optical axis coincides with the chief rays entering said lens; and
an image sensing apparatus receiving light via the lens.

2. An apparatus for examining objects as described in claim 1, wherein said mirrors are plane mirrors.

3. An apparatus for examining objects as described in claim 2, wherein a surface normal for each of said first mirrors intersects the optical axis.

4. An apparatus for examining objects as described in claim 3, wherein a surface normal for each of said second mirrors lies in a plane containing a surface normal for its paired first mirror and the optical axis.

5. An apparatus for examining objects as described in claim 3, wherein said surface normals of said first mirrors are substantially perpendicular to the optical axis.

6. An apparatus for examining objects as described in claim 1, wherein a reflective member having a plurality of plane reflective surfaces functions as said second mirrors, said reflective member being intersected by the optical axis.

7. An apparatus for examining objects as described in claim 1, wherein said second mirrors are joined to form a reflective member, said reflective member being intersected by the optical axis.

8. An apparatus for examining objects as described in claim 1, wherein each first mirror has a reflective surface facing the optical axis, each second mirror has a reflective surface facing away from the optical axis, no first mirror has a reflective surface extending beyond the reflective surface of any adjacent first mirror, and no second mirror has a reflective surface extending beyond the reflective surface of any adjacent second mirror.

9. An apparatus for examining objects as described in claim 1, wherein said mirror pairs are spaced at equal angles around said optical axis.

10. An apparatus for examining objects as described in claim 1, further comprising lights placed around the optical axis illuminating the zone of examination, said lights being oriented such that they do not shine into the lens or interfere with light passing from the zone of examination to any mirror pair.

11. An apparatus for examining objects as described in claim 10, wherein said lights are spaced at equal angles around said optical axis.

12. An apparatus for examining objects as described in claim 1, wherein the size of the mirrors and their distance and orientation with respect to an object in the zone of examination are such that substantially only an image of the object is reflected to the lens.

13. An apparatus for examining objects as described in claim 1, wherein some portion of an area reflected by a mirror pair to the lens is also reflected by another mirror pair to the lens.

14. A method for examining objects, comprising:
providing an apparatus having a plurality of mirror pairs arranged around an optical axis, each pair being comprised of a first mirror and a second mirror, with the first mirror of each pair being proximate a zone of examination intersected by said optical axis and the second mirror of each pair being more distant from the zone of examination, the mirrors of each pair being arranged so that light from the zone of examination impinging on the first mirror of each pair is reflected to the second mirror of each pair and is then reflected from the second mirror of each pair away from the zone of examination and parallel to the optical axis, a substantially telecentric lens located and arranged on said optical axis such that the light reflected from the second mirrors substantially parallel to said optical axis coincides with the chief rays entering said lens, and an image sensing apparatus receiving light via the lens; and
placing an object for examination in the zone of examination.

15. A method for examining objects as described in claim 14, wherein said object can be moved through the zone of examination along any path perpendicularly intersecting the optical axis.

16. A method for examining objects as described in claim 14, wherein an object is not rotated around the optical axis while it is in the zone of examination.

17. An apparatus for examining objects, comprising:
a plurality of plane mirror pairs spaced at equal angles around an optical axis, each pair being comprised of a first mirror and a second mirror, with the first mirror of each pair being proximate a zone of examination intersected by said optical axis and the second mirror of each pair being more distant from the zone of examination, the mirrors of each pair being arranged so that light from the zone of examination impinging on the first mirror of each pair is reflected to the second mirror of each pair and is then reflected from the second mirror of each pair away from the zone of examination and parallel to the optical axis, each first mirror having a reflective surface facing the optical axis, each second mirror having a reflective surface facing away from the optical axis, no first mirror having a reflective surface extending beyond the reflective surface of any adjacent first mirror, and no second mirror having a reflective surface extending beyond the reflective surface of any adjacent second mirror;
a substantially telecentric lens located and arranged on said optical axis such that the light reflected from the second mirrors substantially parallel to said optical axis coincides with the chief rays entering said lens; and
an image sensing apparatus receiving light via the lens.

18. An apparatus for examining objects as described in claim 17, wherein a surface normal for each of said first mirrors intersects the optical axis and a surface normal for each of said second mirrors lies in a plane containing a surface normal for its paired first mirror and the optical axis.

19. An apparatus for examining objects as described in claim 18, wherein a reflective member having a plurality of plane reflective surfaces functions as said second mirrors, said reflective member being intersected by the optical axis.

20. An apparatus for examining objects as described in claim 18, wherein said second mirrors are joined to form a reflective member, said reflective member being intersected by the optical axis.

21. An apparatus for examining objects as described in claim 19, further comprising lights arranged in an axially symmetrical manner around the optical axis illuminating the zone of examination, said lights being oriented such that they do not shine into the lens or interfere with light passing from the zone of examination to any mirror pair.

22. An apparatus for examining objects as described in claim 21, wherein the size of the mirrors and their distance and orientation with respect to an object in the zone of examination are such that substantially only an image of the object is reflected to the lens.

23. An apparatus for examining objects as described in claim 22, wherein some portion of an area reflected by a mirror pair to the lens is also reflected by another mirror pair to the lens.
